(19) United States
(12) Patent Application Publication
(10) Pub. No.: US 2014/0262360 A1
(43) Pub. Date: Sep. 18, 2014

(54) PORTABLE SAFETY DEVICE CONTAINER

(71) Applicant: Troy A. Stille, Mason City, IA (US)

(72) Inventor: Troy A. Stille, Mason City, IA (US)

(21) Appl. No.: 14/200,095

(22) Filed: Mar. 7, 2014

Related U.S. Application Data
(60) Provisional application No. 61/782,709, filed on Mar. 14, 2013.

(51) Int. Cl. B65D 1/40; A62C 8/00

(52) U.S. Cl. CPC B65D 1/40; A62C 8/00
USPC 169/51; 220/523

(57) ABSTRACT

A safety device container that has a divider with a cut-out section disposed within the chamber of the container to immobilize and protect a safety device. The container having a first and second housing that when in a closed position the second housing engages a ledge of the first housing.

### CROSS REFERENCE TO RELATED APPLICATION

This application claims the benefit of U.S. Provisional Application No. 61/782,709 filed Mar. 14, 2013.

### BACKGROUND OF THE INVENTION

This invention is directed toward a portable safety device container and more particularly to a portable container for a fire extinguisher and eye wash container.

Typically, when performing industrial work and maintenance, safety devices such as fire extinguishers, eye wash containers, and the like are carried by workers. Particularly, when working with wind energy, oil rigs, and off-road systems, the safety device can be dropped or damages such that the trigger mechanism is crushed and either discharges or becomes inoperable. To guard against this, a container is needed that not only protects the safety device, but also immobilizes the trigger mechanism.

An objective of the present invention is to provide a portable safety device container that protects the safety device from damage.

A further objective of the present invention is to provide a portable safety device container that prevents discharge upon impact.

A still further objective of the present invention is to provide a portable safety device container that provides easy access.

These and other objectives will be apparent to one of ordinary skill in the art based upon the following written description.

### SUMMARY OF THE OF THE INVENTION

A safety device container that has a divider with a cut-out section disposed within the chamber of the container to immobilize and protect a safety device. The container having a first and second housing that when in a closed position the second housing engages a ledge of the first housing.

### DESCRIPTION OF THE DRAWINGS

FIG. 1 is a perspective view of a safety device container;

FIG. 2 is a side view of a safety device container; and

FIG. 3 is a top view of a safety device in a first housing of a safety device container.

### DETAILED DESCRIPTION

Referring to the Figures the container 10 has a first housing member 12 and a second housing member 14 that fit together to form a hollow chamber 16 formed to receive a safety device 18 such as a fire extinguisher, and eye wash container or the like. The first housing member 12 has a first end 20 and a second end 22 with an elongated sidewall 24 therebetween that is preferably arucate. In one embodiment, the sidewall 24 has a flat indented section 25 that can hold instructions or other materials. Extending inwardly around the sidewall 24 and ends 20 and 22 is a ledge 26.

Between ends 20 and 22, and within chamber 16 is a divider 28 that separates the first housing member 12 into a first section 30 and a second section 32. The divider has a centrally located cut-out section 34 that preferably is acruate. The first housing member 12 is formed to tightly receive the safety device 18. The divider 28 is positioned such that a body 36 of the safety device 18 is received within the first section 30, a neck 38 of the safety device 18 extends through the cut-out section 34 of the divider 28, and a head 39 of the safety device within the second section 32. In one embodiment, the safety device 18 has a head 39 having a nozzle 40 and actuating arms 41 that are received within the second section 32.

The second housing member 14 has a first end 42, a second end 44, and a sidewall 46 that extends therebetween formed to receive the opposite side of the safety device 18. Disposed within the chamber 16 of the second housing 14 is a second divider 48 that is positioned to align vertically with the first divider 28 when the container 10 is in a closed position. The second divider 48 has a cut-out section 50 that preferably is arcuate. The sidewall 46 and ends 42 and 44 of the second housing 14 are formed to fit tightly within the sidewall 24 and ends 20 and 22 of the first housing 12 such that the outer edge 52 of the second housing 14 engages the ledge 26 of the first housing 12.

The first housing 12 and second housing 14 are hingedly connected. In one embodiment, the first housing 12 has a plurality of flattened hooks 54 that extend outwardly from the second end 22. In another embodiment a single hook 54 can be used. The plurality of hooks 54 are received within slots 56 that extend outwardly from the second end 44 of the second housing 14.

At the first end 20 of the first housing 12 and the first end 42 of the second housing 14 is a releasable fastening member 58. In one embodiment, the fastening member 58 has a rounded portion 60 that extends outwardly from the first end 20 of the first housing 12 that snaps into a notch 62 that extends outwardly from the first end 42 of the second housing. In one embodiment the notch 62 has an elongated portion 64 to facilitate removal of the notch 62 from the rounded portion 60. In alternative embodiments the fastening member 54 is located anywhere on the exterior of the container 10 and is of any size, shape, or structure.

In operation, the safety device 18 is placed within chamber 16 of the first housing 12. The safety device 18 is received by the first housing 12 such that the body 36 of the safety device 18 is immobilized by the first section 30 and the neck 38 is immobilized by the cut-out section 34 of the divider 28. The head 39 of the safety device 18 is isolated in the second section 32 to prevent triggering the safety device. The second housing 14 is then fit within the first housing 12 such that outer edge 52 engages ledge 26. In this way the divider 48 of the second housing 14 is aligned with the divider 28 of the first housing 12 to secure the neck 38 of the safety device in the cut-out sections 32 and 52. Then the fastening member 58 is secured such that the container 10 is locked in a closed position.

What is claimed:

1. A safety device container comprising:
a first housing having a first end, a second end, and a sidewall;
a second housing having a first end, a second end, and a sidewall hingedly connected to the first housing to form a chamber; and
a divider positioned within the chamber having a cut-out section.

2. The container of claim 1 further comprising a ledge extending inwardly around the sidewall, first end, and second end of the first housing.

3. The container of claim 2 wherein the second housing is formed to fit within the first housing such that the second housing engages the ledge of the first housing.

4. The container of claim 1 further comprising the sidewall of the first housing having a flat indented section.

5. The container of claim 1 further comprising a releasable connecting member attached to the first end of the first housing member and the first end of the second housing member.

6. The container of claim 1 wherein when a safety device is placed within the container the safety device is immobilized within the chamber.

7. The container of claim 1 wherein the first housing and second housing are formed to tightly fit around a safety device.

8. The container of claim 1 wherein the safety device is a fire extinguisher.
